(19) United States
(12) Patent Application Publication
(10) Pub. No.: US 2008/0163865 A1
(43) Pub. Date: Jul. 10, 2008

(54) Portable Folding Roaster

(76) Inventor: Wei-Teh Ho, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/621,925

(22) Filed: Jan. 10, 2007

(51) Int. Cl. A47J 37/07; A47J 37/04; F24C 3/00

(52) U.S. Cl. 126/9 B; 99/421 H; 126/39 BA

(57) ABSTRACT

A portable folding roaster comprises: a heating box, having a baffle disposed therein and a partition disposed at the bottom thereof, a heat source being disposed between the baffle and the partition, and the baffle having small apertures arranged on the surface thereof for facilitating heat dissipation; a folding leg stand, having a base there over for fixing the heating box, the base having a plurality of supporting legs pivoted there below such that the supporting legs may be opened or closed with respect to the base; and a roasting tool, disposed on the heating box, and being used for holding food materials.

### BACKGROUND OF THE INVENTION

1. Field of the Invention

The present invention relates to a portable folding roaster and, in particular, to a cooking apparatus equipped with a folding leg stand, which can be carried without occupying much space, set up for use in various landscapes, and arranged with various tools for roasting various materials manually or automatically, and is easy to clean and treat for collection of oil and meets the requirement for environmental protection and economy.

2. Descriptions of the Related Art

As the material civilization progresses, people live in fast-pace lives than ever before, which make them under so much stress that it's almost too difficult to breathe. Therefore, people have begun to consider the need in their spiritual life and thus the importance on leisure time, in which they hope for enlivening their busy lives.

In those modern leisure activities usually taken by people, roasting (e.g., barbeque) may be one winning acceptance. By roasting, everyone can cultivate his mind and can strengthen relationship with others, not to mention the delicious food made in the process.

However, for traditional activities of roasting, it is indispensable to pay attention for preparing various roasting tools, e.g., barbeque rack, charcoal, etc., as well as food materials. Those tools, though being available, require care to prepare and minor carelessness may spoil the whole activity (thus, negatively affect the event and further resulting in quarrel among participants).

Besides, the activities of roasting may involve consideration of the landscape since most of these activities take place outdoors. Some roasting tools may not be easy to set up and may tend to topple when operated, destroying the food materials in the process and may even create fire hazard.

Moreover, trash or ash may left behind by improper roasting tools contaminate the environment over time and create fire hazard.

Therefore, a roasting apparatus is to be conceived that is required to be ingenious and facile, convenient to carry and easy to set up, and environmentally-friendly. Furthermore, the roasting apparatus meets the requirement for home-use, as well as for outdoor-use. The inventor has developed this portable folding roaster successfully after long-term research and experimentation.

### SUMMARY OF THE INVENTION

The primary objective of this invention is to provide a portable folding roaster that is easy to operate and can be set up for use in various landscapes and includes a selection of roasting tools for various usage depending on the properties of food materials for roasting, and capable of promoting the pleasure of roasting activity.

Another objective of this invention is to provide a portable folding roaster that is light in size and convenient to carry during travel in a car, and can be placed in the house for use. Such properties are desirable use especially for people living in the metropolis where land is very precious.

A further objective of this invention is to provide a portable folding roaster that meets the requirement for environmental protection where trash or ash can be processed centrally, avoiding contamination of the environment.

Yet a further objective of this invention is to provide a portable folding roaster that is provided with gas and electric heating means concurrently, which may be used selectively as required so as to fulfill more general purpose.

A portable folding roaster for achieving the above objectives principally comprises: a heating box, having a cover disposed there over for closing the heating box so that the heating box may be kept clean inside when not used in roasting; a folding leg stand, disposed under the heating box, and having a base there over for fixing the heating box, the base having a plurality of supporting legs pivoted there below such that the supporting legs may be opened or closed with respect to the base (that is, the portable folding roaster of the present invention may be set up in various landscapes successfully with the opened plurality of supporting legs and the portable folding roaster may have reduced volume for the convenience of being carried and stored when the supporting legs are closed); and roasting tools, disposed on the heating box, and being used for holding food materials to roast in the heating box.

### BRIEF DESCRIPTION OF THE DRAWINGS

The drawings disclose an illustrative embodiment of the present invention that serves to exemplify the various advantages and objects hereof, and are as follows:

FIG. 1 is a 3-dimensional diagram for the present invention;

FIG. 2 is a 3-dimensional diagram of a closed roasting oven of the present invention;

FIG. 3 is a detailed structure diagram of the roasting oven of the present invention;

FIG. 4 is a diagram for an embodiment of a set up auxiliary stand of the present invention;

FIG. 5 is a diagram for an embodiment of a set up roasting stick of the present invention;

FIG. 6 is a diagram for an embodiment of a variably set up roasting stick of the present invention;

FIG. 7 is a 3-dimensional diagram for an embodiment of applied roasting cylinders of the present invention;

FIG. 8 is a 3-dimensional diagram for an embodiment of an applied roasting mesh of the present invention;

FIG. 9 is a 3-dimensional diagram for an embodiment of an applied roasting pan of the present invention;

FIG. 9A is a 3-dimensional diagram for an embodiment of a variably applied roasting pan of the present invention;

FIG. 9B is a 3-dimensional diagram for another embodiment of a variably applied roasting pan of the present invention;

FIG. 10 is an exploded view for an embodiment of a control chamber of the present invention; and

FIG. 11 is an exploded view for another embodiment of a control chamber of the present invention.

### DESCRIPTION OF THE PREFERRED EMBODIMENT

In the following, preferred embodiments of the present invention will be described in details accompanying with the drawings, in order for the examiners to further appreciate and understand the structure, usage and features of the invention more deeply, specifically, fully and accurately.

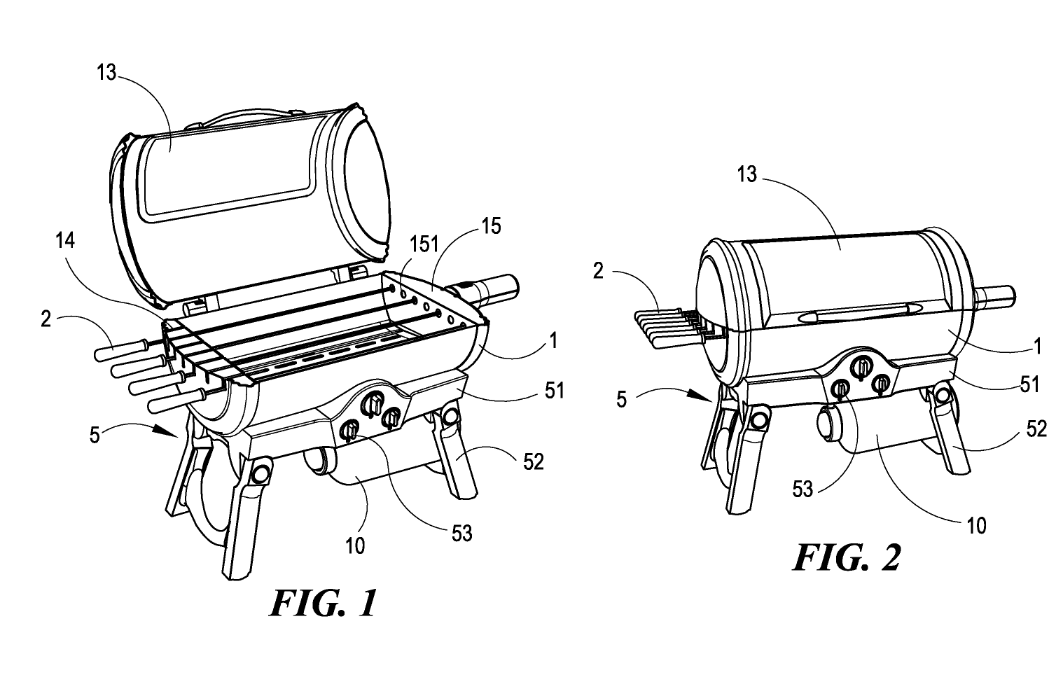

Refer to FIGS. 1 and 2. The present invention provides a portable folding roaster, the roaster principally comprising: a heating box 1, having a cover 13 disposed there over for closing the heating box 1 so that the heating box 1 may be kept clean inside when not used in roasting; a folding leg stand 5, disposed under the heating box 1, and having a base 51 there over for fixing the heating box 1, the base 51 having a plurality of supporting legs 52 pivoted there below such that the supporting legs 52 may be opened or closed with respect to the base 51 (that is, the portable folding roaster of the present invention may be set up in various landscapes successfully with the opened plurality of supporting legs 52 and the portable folding roaster may have reduced volume for the convenience of being carried and stored when the supporting legs 52 are closed); and roasting tools, disposed on the heating box 1, and being used for holding food materials to roast in the heating box 1.

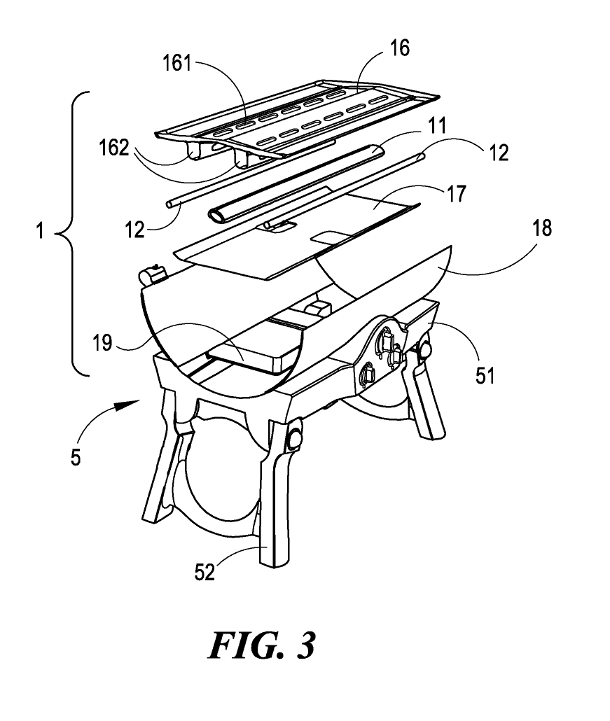

Refer to FIG. 3. The heating box 1 has a casing 18 fixed on the base 51 of the folding leg stand 5, a baffle 16 disposed therein and a partition 17 disposed at the bottom thereof, wherein a heat source is disposed between the baffle 16 and the partition 17, and the baffle 16 has a plurality of small apertures 161 arranged on the surface thereof and diversion channels 162 disposed under the small apertures 161, the diversion channels 162 each having the outlet thereof extending to the underside of the partition 17 where an oil collection case 19 is disposed. In this way, when the heat source is turned on, heat may be scattered uniformly via the small apertures 161 onto the roasting tools while waste oil produced in roasting may be collected via the small apertures 161 into the diversion channels 162 and centralized through the diversion channels 162 into the oil collection case 19, and then oil collection case 19 can be drawn out to properly dispose the oil collected, thus keeping the environment clean. In addition, the partition 17 at the bottom of the heating box 1 may also prevent the waste oil from accidentally dropping onto the base 51, thus preventing flame or high heat flow from contacting the oil collection case 19 and result in burning. As such, this contemplated design enhances the security of roasting.

Said heat source may be an electric heating pipe 12 or a gas-jetting pipe 11, disposed alone or concurrently, wherein the electric heating pipe 12 has an external power source disposed as conventionally arranged. The gas-jetting pipe 11 must be used along with a gas cylinder 10, which may be disposed in various ways (The gas cylinder 10 is mounted under the base 51 in this example); and the base 51 may have a regulation chamber disposed thereon for the electric heating pipe 12 or the gas-jetting pipe 11, the regulation chamber having a regulation switch 53 extending to the surface of the base in order for the user to operate or control.

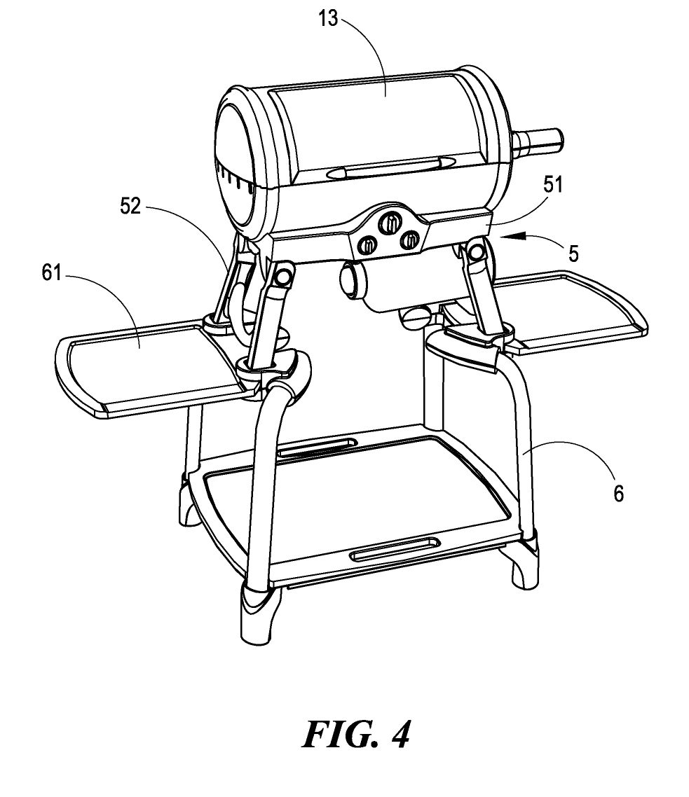

Refer to FIG. 4. The portable folding roaster of the present invention may have a removable auxiliary stand 6 disposed under the folding leg stand 5. Based on the place and space availability for roasting, the auxiliary stand 6 may be set up first, prior to placing the folding leg stand 5 on the auxiliary stand 6. This way, the user may adjust the height of the portable folding roaster for the convenience of placement in the house or stand-alone use. The auxiliary stand 6 has a plurality of mobile stages 61 disposed thereon, the mobile stages 61 may be fixed at appropriate positions on the auxiliary stand 6, depending on the use requirement, for placing the food materials, containers, and eating utensils, etc, for the convenience of centralized management.

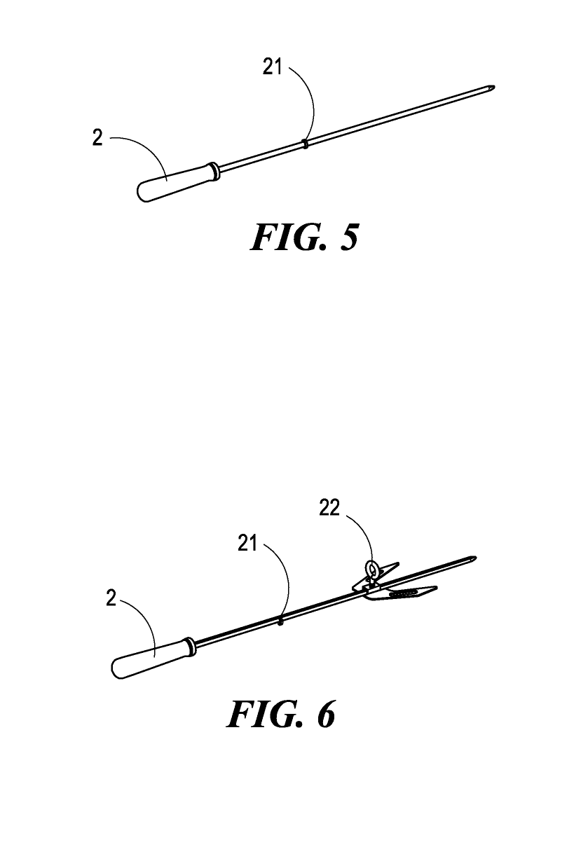

Further refer to FIGS. 1 and 5. Said roasting tools may be chosen, depending on the types of the food material. For example, roasting sticks 2 may be chosen for stringing the material to roast. The detailed method of operating the roasting sticks 2 comprises: positioning each of the roasting sticks 2 on one of a plurality of notches 14, which are disposed on one side of the heating box 1; sticking each of the roasting sticks 2 by one end through one of a plurality of sockets 151 of a control chamber 15, which is disposed on the other side of the heating box 1 and has a plurality of sockets 151 disposed thereon and numbering equal to the notches 14; and, thereby threading the food materials with the roasting sticks 2 and performing automatic rotary action of the roasting sticks 2 with the machines in the control chamber 15.

Yet refer to FIG. 5. In order to prevent the roasting sticks 2 from detachment during rotation, a positioning ring 21 may be added to the roasting sticks 2, such that the positioning ring 21 can be positioned against the wall surface of the heating box 1. Refer to FIG. 6, the roasting stick 2 may have a fork 22 disposed thereon for insertion into the material so that the roasting sticks 2 can be rotated stably to perform the roasting.

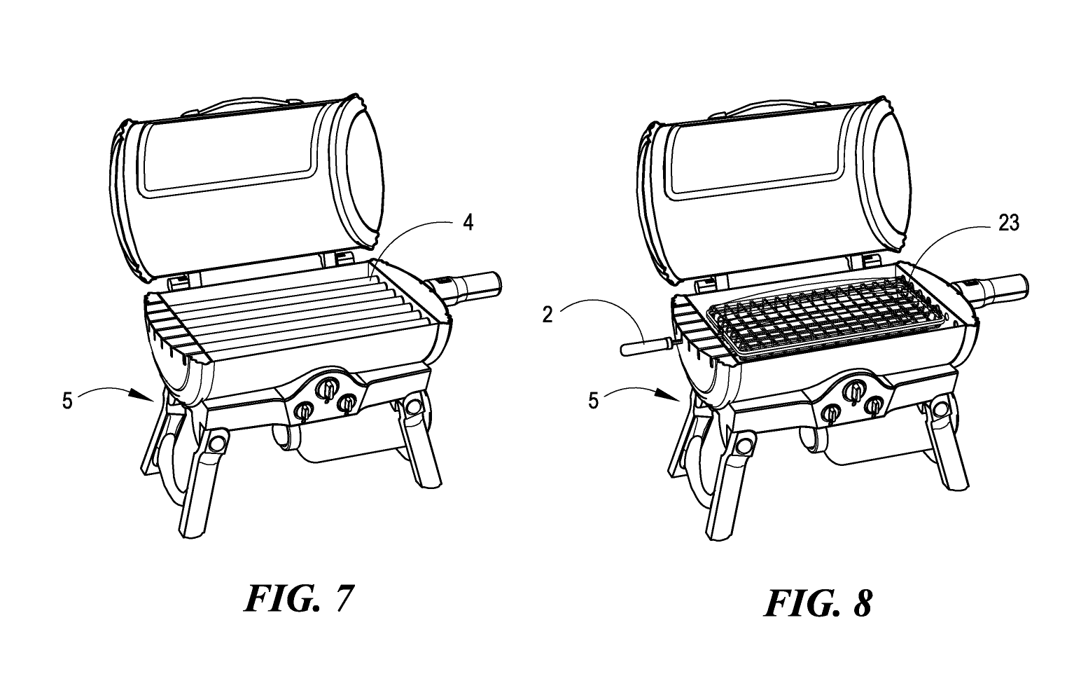

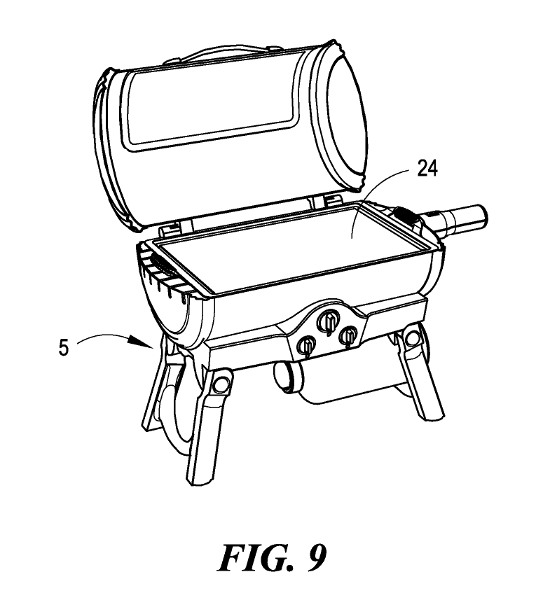

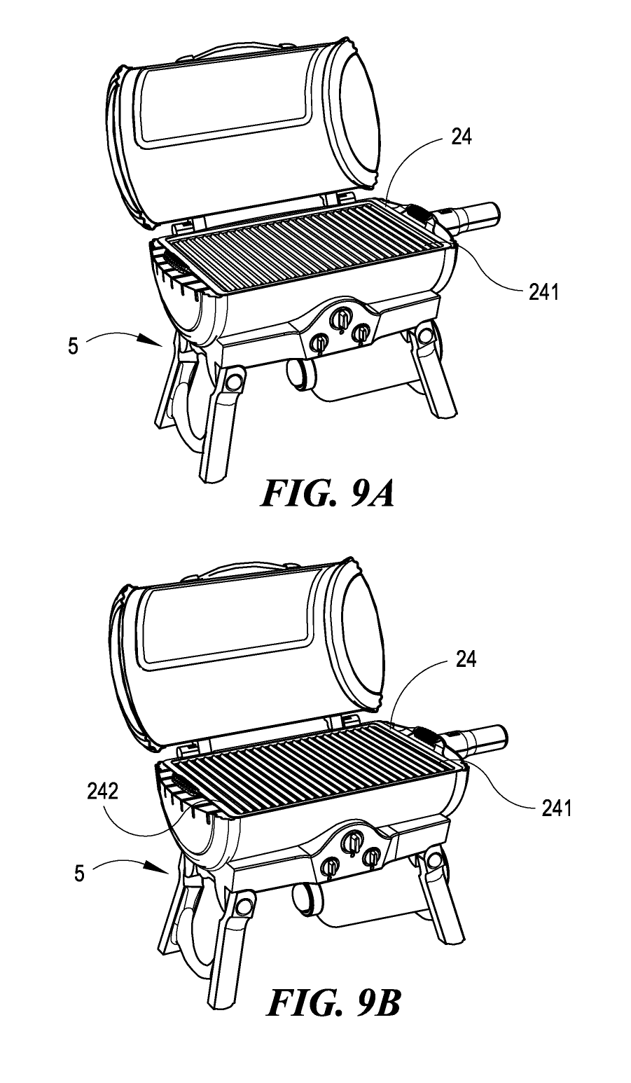

Refer to FIG. 7. The roasting tools may include roasting cylinders 4 for rolling the food materials thereon. Alternatively referring to FIG. 8, the roasting tools may include a roasting mesh 23 having self-set handles or being fixed by the stuck roasting sticks 2, for heating the materials placed therebetween. Refer to FIG. 9 to 9B. The roasting tools may include a roasting pan 24 being flat or having an additional ribbed pattern 241 and even having designed oil-exhausting holes 242 thereon, for heating the materials placed thereon. Of course, the roasting tools may include other known roasting tools differing from those described above.

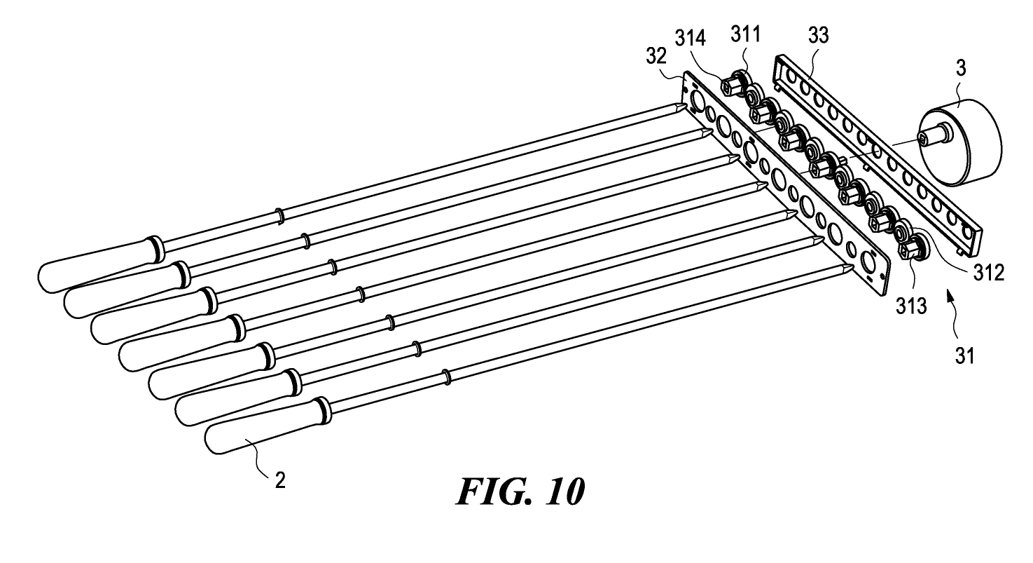

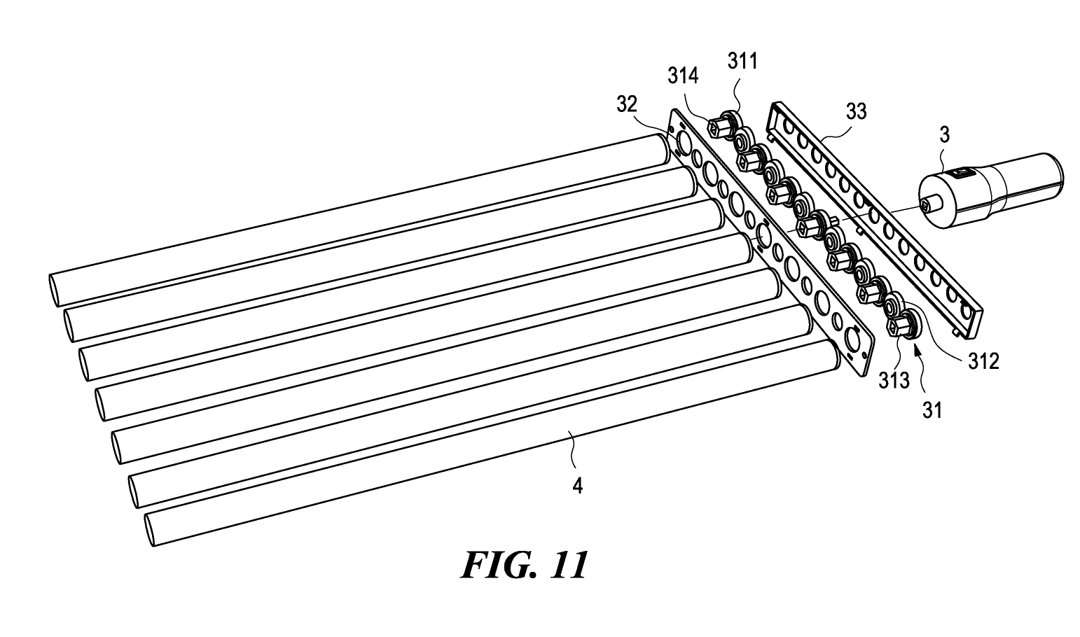

Refer to FIGS. 10 and 11. Said control chamber 15 has a control handle 3 extending outside thereof. The control handle 3 has a motor disposed inside thereof (not shown), and the motor inside the control handle 3 has the power output shaft thereof connected to a gear set 31 having two covering plates 32, 33 packaged outside thereof for completion of positioning the gear set 31. Gear set 31 comprises a plurality of gears 311 that are engaged with one another for transmission of power or use a transmission wheel 312 between any pair thereof for transmission of power. The gears 311 each have a positioning block 313 protruding through the covering plate 32, and the positioning blocks 313 each are aligned with one of the sockets 151, and have a positioning hole 314 disposed in the center thereof, so that the front end of the roasting stick 2 may be stuck through the positioning hole 314 as one end of the roasting stick 2 is positioned on the notch 14. Roasting stick 2 may be driven to rotate by the motor inside the handle 3, wherein the roasting stick 2 and the corresponding positioning hole 314 are shaped to be polygonal so that the roasting stick 2 cannot rotate in the positioning hole 314, thus enhancing its stability. The end of each of the roasting cylinders 4 is put around the periphery of one of the positioning blocks 313, wherein the roasting cylinder 4 and the positioning block 313 have a contact face shaped to be polygonal to enhance stability. The roasting cylinder 4 is driven to rotate by the motor inside the control handle 3. In addition, the control handle 3 may have batteries mounted therein for driving the motor.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A portable folding roaster, comprising:
a heating box, having a baffle disposed therein and a partition disposed at the bottom thereof, a heat source being disposed between the baffle and the partition, and the baffle having a plurality of apertures arranged on the surface thereof for facilitating heat dissipation;
a folding leg stand, having a base disposed there over for fixing the heating box, the base having a plurality of supporting legs pivoted there below such that the supporting legs can be opened or closed with respect to the base; and
a roasting tool, disposed on the heating box, and being used for holding food materials.

2. The portable folding roaster according to claim 1, wherein the heating box has a cover disposed there over for closing the heating box.

3. The portable folding roaster according to claim 1, wherein the baffle has diversion channels disposed thereon, the diversion channels each having the outlet thereof extending to the underside of the partition where an oil collection case is disposed so that waste oil can be centralized via the small apertures into the diversion channels and flow through the diversion channels into the oil collection case.

4. The portable folding roaster according to claim 1, wherein the heating box has a control chamber disposed on one end thereof, the control chamber has a motor disposed therein, the motor has the power output shaft thereof connected to a gear set, the gear set comprises a plurality of gears, the gears each have a positioning block protruding out of the control chamber for positioning and rotating the roasting tool.

5. The portable folding roaster according to claim 4, wherein the roasting tool is a roasting stick, the positioning block has a positioning hole disposed in the center thereof, the heating box has notches disposed on the side other than that side on which the positioning blocks are disposed, so that the roasting stick can be positioned on one corresponding notch and stuck by one end thereof into one corresponding positioning hole to perform electric rotation.

6. The portable folding roaster according to claim 5, wherein the roasting stick and the corresponding positioning hole are shaped to be polygonal.

7. The portable folding roaster according to claim 5, wherein the roasting stick has a positioning ring disposed thereon such that the positioning ring can be positioned against the wall surface of the heating box so as to prevent the roasting stick from detachment from the notch.

8. The portable folding roaster according to claim 5, wherein the roasting stick has a fork disposed thereon for insertion into the material so that the roasting stick can be rotated to perform the roasting.

9. The portable folding roaster according to claim 4, wherein the gears are engaged with one another for transmission of power or use a transmission wheel between any pair thereof for transmission of power.

10. The portable folding roaster according to claim 4, wherein the roasting tool is a roasting cylinder, the end of each of the roasting cylinders being put around the periphery of one corresponding positioning blocks.

11. The portable folding roaster according to claim 10, wherein the roasting roller and the corresponding positioning block are shaped to be polygonal.

12. The portable folding roaster according to claim 1, wherein the roasting tool is a roasting mesh, the roasting mesh having self-set handles or being fixed by the stuck roasting sticks, for roasting the materials placed therein.

13. The portable folding roaster according to claim 1, wherein the roasting tool is a roasting pan.

14. The portable folding roaster according to claim 1, wherein the base has a regulation chamber disposed thereon, the regulation chamber being used for managing the start and fire of the heat source.

15. The portable folding roaster according to claim 1, wherein the heat source is an electric heating pipe, the electric heating pipe having an alternating power source.

16. The portable folding roaster according to claim 1, wherein the heat source is a gas-jetting pipe, the gas-jetting pipe being mounted under the base.

17. The portable folding roaster according to claim 1, wherein a removable auxiliary stand is disposed under the folding leg stand, to be set up depending on the space requirement, for placing the folding leg stand thereon.

18. The portable folding roaster according to claim 17, wherein the auxiliary stand has a plurality of mobile stages disposed thereon, the mobile stages being fixed on the auxiliary stand depending on the use requirement.
